(19) United States
(12) Patent Application Publication
(10) Pub. No.: US 2008/0223227 A1
(43) Pub. Date: Sep. 18, 2008

(54) METHOD AND APPARATUS FOR APPLYING A LIQUID CONTAINING A POST-HARVEST TREATMENT ORGANIC COMPOUND TO GENERALLY SPHERICAL OR OVOID AGRICULTURAL PRODUCE ITEMS

(76) Inventors: Steven E. Robbs, Boise, ID (US); Ethan E. Janke, Burbank, WA (US)

Correspondence Address: Angus C. Fox, III, 4093 N. Imperial Way, Provo, UT, 84604-5386, US

(21) Appl. No.: 11/687,329

(22) Filed: Mar. 16, 2007

(51) Int. Cl. A23B 7/14; A01N 47/10

(52) U.S. Cl. 99/534; 504/143

(57) ABSTRACT

An apparatus for applying a liquid containing a post-harvest-treatment organic compound to generally spherical or ovoid produce items, the apparatus including: a first set of cylindrical brushes, each rotatable about its axis in a first direction, the axes of the first set of brushes being generally parallel, lying generally in a common horizontal plane, and positioned sufficiently close to one another to create a rolling transport platform having a series of alternating peaks and troughs for the items; a second set of at least one brush positioned above the first set so that the bristles of both sets are deformed as the items pass between them. The liquid is applied to the second brush set, which may include multiple rotating cylindrical brushes having horizontal parallel axes, at least one stationary or movable flat brush, multiple right-conical section brushes, or multiple cylindrical brushes having skewed, horizontal axes.

### BACKGROUND OF THE INVENTION

1. Field of the Invention

This invention relates to a method and apparatus for applying a sprout inhibiting emulsion to tubers, such as potatoes, that are being distributed for sale.

2. Description of Related Art

It is often desirable to store certain agricultural produce until a sale under favorable economic terms can be consummated and the produce delivered to the purchaser. During storage, it is essential that freshness of the produce be maintained. Tubers, such as potatoes, are frequently stored as bulk piles in quantities of 2,270,000 to over 22,700,000 kilograms (5,000,000 to over 50,000,000 U.S. lbs.) in dark, underground storage cellars where the temperature is maintained within a range of about 4.5° C. to 12.8° C. (approximately 40 to 55° F.). Untreated tubers will generally sprout over time, even in the absence of light. If the sprouting is allowed to continue unchecked, the tubers become commercially worthless.

Maleic hydrazide and isopropyl-3-chlorocarbonilate (an organic compound commonly known as CIPC or chlorpropham) are the two compounds most commonly used as sprout inhibitors. Maleic hydrazide is applied to the growing potato crop and is translocated to the developing tubers where it arrests cell division, but does not limit cell expansion. If it is applied too early during tuber development it will limit tuber size and yield.

Use of isopropyl-3-chlorocarbonilate (hereinafter CIPC) as a potato sprout inhibitor was first reported by P. C. Marth in 1952, and its use for that purpose was later patented by the Pittsburgh Plate & Glass Co. The molecular structure of CIPC is depicted in FIG. 1. CIPC has a molecular weight of 213.66, a melting point of about 41° C., a vaporization temperature of about 246° C., and a vapor flash point of about 427° C. CIPC inhibits potato sprout development by interfering with spindle formation during cell division. Cell division is extremely important during the wound healing or curing period after potatoes are placed into storage. Wound healing requires the production of two to five new cell layers formed by cell division. If CIPC is applied to the potatoes before the wound healing process is complete, excessive losses due to tuber dehydration and disease can occur. CIPC may be applied any time after the wound healing process is complete but before the tubers break dormancy in early spring. In order to suppress the sprouting of a tuber, the tuber must be covered with a thin film of chloroprofam.

Several methods have been developed for applying CIPC aerosols to potatoes in bulk storage. U.S. Pat. No. 4,226,179 to Sheldon, III et al. discloses a process whereby CIPC, either without solvent or with a relatively small amount of solvent, is atomized at a temperature of less than 121° C. The aerosol is formed in a fogger having a cylindrical mist chamber in which ultrasonic resonance nozzles atomize the chemical agent. A tangentially introduced air flow and a helical baffle plate in the mist chamber cause centrifugal separation, leaving smaller particles near the center of the mist chamber. These small particles are carried by an airflow duct to a storage chamber containing potatoes. The aerosol condenses on the potatoes, thereby forming a growth inhibiting film thereon. U.S. Pat. No. 5,723,184 to Yamamoto discloses a process whereby CIPC is heated to a molten state, pressurized, further heated and introduced into a heated airstream that is ducted to a storage chamber containing potatoes. U.S. Pat. No. 5,935,660 to Forsythe, et al. discloses a process similar to that of Yamamoto whereby solid CIPC is melted and then converted to an aerosol either by a pressurized hot air stream or by a combustion gas stream. U.S. Pat. No. 6,432,882 to Yamamoto discloses several methods and multiple apparatus for atomizing or vaporizing CIPC without the need for converting the compound to a liquid. Fundamentally, the process includes the steps of forming minute particles of solid CIPC particles from a larger block or chunks of solid CIPC, and inducting the particles into an airstream wherein the particles are provided with sufficient thermal energy to convert them into an aerosol. The airstream is directed to a potato storage facility and allowed to bathe tubers stored therein. U.S. Pat. No. 6,790,469 to Robbs, et al. discloses both a process and apparatus for treating tubers in storage with chlorpropham (CIPC) dust or the dust of any other similar organic compound. For one embodiment of the invention, blocks or chunks of solid CIPC are fed into a hammer mill or like apparatus, which pulverizes the solid CIPC. Insufficiently fine particles are returned to the mill for further pulverization. Fine powder consisting of particles, each of which has a major dimension of less than about 5 micrometers, is transported by the ducted airstream from the separator to a storage shed containing a pile of tubers. The powder filters through the pile and coats exposed surfaces of the exposed tubers.

When tubers are removed from storage—usually months after an initial sprout-inhibition treatment—it is generally preferable to subject the tubers to a final sprout-inhibition treatment before they are bulk-packed, fresh-packed or bagged and shipped to wholesalers, retailers and processors. For the final sprout-inhibition treatment, an emulsion containing CIPC is typically applied directly to the tubers. An emulsion is a suspension of a non-polar compound, such as oil, in a polar liquid, such as water. The emulsified CIPC is generally applied to the tubers as a direct spray shortly before shipment. A film of CIPC remains on the surface of the potatoes after the water component of the emulsion evaporates. It is particularly important that the eyes of the potatoes be covered by the CIPC emulsion, as cell division related to sprouting begins at those locations. If the potatoes are completely covered with the emulsion, the resulting CIPC film will inhibit sprout formation for up to a year. Over time, as the CIPC molecules on the surface of the potatoes sublimate into the ambient atmosphere, the effectiveness of the sprout inhibition treatment is reduced. As the rate of sublimation increases with increasing temperature, storage life will be enhanced by maintaining the treated potatoes in a cool environment.

A primary deficiency of the emulsion spray treatment is that it is difficult to completely cover the surface of all tubers being treated. This is particularly true in the eye regions of the tubers, which are generally recessed somewhat from the main surface of a potato. Consequently, there is a need for an improved method and apparatus for applying a CIPC emulsion to tubers, that will ensure complete coverage of the eyes and outer surface of each tuber, thereby improving sprout inhibition from the time they are shipped until they are prepared for consumption.

### SUMMARY OF THE INVENTION

The present invention provides both a method and apparatus for applying an emulsion containing a sprout-inhibiting organic compound to tubers that ensures complete coverage of the eyes and outer surface of each tuber. Although developed for the purpose of applying emulsions containing isopropyl-3-chlorocarbonilate to tubers, it is also contemplated that the method and apparatus may be used to apply other sprout inhibiting compounds, such as maleic hydrazide or essential oils, to tubers or, more generally, to apply liquids containing a post-harvest-treatment organic compound to any generally spherical or ovoid agricultural produce items. It is further contemplated that the organic compounds—whether they be sprout inhibitors or other post-harvest-treatment compounds—may be applied as a solution, a diluted or concentrated organic liquid, or as a water-based emulsion, depending on the physical properties of the organic compound. The method and apparatus are disclosed in the context of reapplying a sprout inhibitor to tubers after they have been removed from long-term, multi-month storage in order to improve sprout inhibition before they are fresh-packed in bags, boxes, or in bulk loads for delivery to distribution channels. The apparatus of the present invention represents an adaptation and modification of an apparatus that has heretofore been used to wax apples in order to enhance their cosmetic appearance.

Utilizing the prior art waxing apparatus, apples are transported on a conveyor belt to a spray station, where the conveyor belt is replaced by a series of rolling cylindrical brushes. As the apples tumble over the rolling brushes, at least one nozzle or dripper moves back and forth on an overhead track which is perpendicular to the path of travel, spraying or dripping a wax emulsion onto the brushes and apples.

The present invention provides a sprout inhibitor application station that builds on the emulsion waxing system so that tubers can be completely covered with an emulsion containing CIPC, thereby optimizing sprout inhibition. In addition to the bottom set of rolling cylindrical brushes beneath the produce being treated, there is at least one moving brush on top of the produce. The distance between the lower and upper sets of rolling brushes is adjusted so that the bristles of both the lower and upper sets of brushes are deformed and scrub the upper and lower surfaces of the tubers 205 as they pass between the two brush sets. The bristles on both the lower and upper sets of brushes ensure generally uniform coating of the surface of each of the tubers which pass between the two sets of brushes. For a first embodiment, a plurality of parallel cylindrical brushes having their axes parallel to those of the rolling cylindrical brushes beneath the produce are employed. To ensure optimum emulsion coverage of the brushes, either drip or spray applicators for the sprout inhibiting emulsion are placed on a laterally reciprocating trolley. For a second embodiment, the cylindrical brushes of the upper set are, along with the sprout inhibitor emulsion dispensers, mounted on a laterally reciprocating trolley. The reciprocation of the upper set of brushes promotes rolling and tumbling of the treated tubers. For a third embodiment, the upper brushes are equipped with either a right-hand or left-hand helical groove. As the brushes rotate, the helical grooves promote rolling and tumbling of the treated tubers. So that the tubers are not directed to a single side of the track, brushes having right and left-hand helical grooves are installed in pairs. For a fourth embodiment, the rolling brushes of the bottom set transport the tubers beneath a single planar brush, which is moved laterally back and forth or orbitally to promote rolling and tumbling. For a fifth embodiment, each of the upper set of brushes is in the shape of a right-conical section, with each brush being installed above the lower set of brushes so that it lower profile is parallel to that of the lower brushes. The use of conical brushes creates a speed differential of the brush bristles over the length of the brush that is proportional to the distance from the apex of the cone. This speed differential generates a spinning moment in a horizontal plane on each of the tubers as they travel on the lower set of brushes. For a sixth embodiment, pairs of brushes of the upper set are angled in opposite directions to cause the tubers to first spin in one direction and, then, in the other. So that the tubers are not directed to a single side of the track, brushes having rotational axes which are non-parallel to the rotational axes of the cylindrical brushes of the lower set are installed in oppositely-angled pairs. The sprout inhibitor emulsion is either sprayed or dripped onto the bristles of at least one of the upper set of brushes. Dripping of the emulsion onto the brushes is generally preferred over spraying, as an emulsion tends to clog spray nozzles. In order to ensure complete coverage of the upper brush or brushes, one or more drip tubes are attached to a trolley that is movable on a track that is directly above and parallel to the axis of each brush to which the emulsion is being dispensed. The trolley moves back and forth at a generally constant rate while the emulsion escapes from the drip tube or tubes at a generally constant rate, thereby enabling the drip tube or tubes to traverse the entire length of the brush. The trolley may be actuated by any of several available common drive systems, such as pneumatic, hydraulic, or electric. Having an upper set of brushes with non-parallel axes complicates the drive system. However, the brushes with non-parallel axes can be powered individually with a separate motor for each brush, or powered with a single motor using a single belt or chain through a system of flexible couplers, U-joints or constant-velocity joints, or even bevel gear drives.

### BRIEF DESCRIPTION OF THE DRAWINGS

FIG. 1 depicts the chemical structure of chlorpropham (CIPC);

FIG. 2 is an elevational view of a double-layer rotating brush system for applying a sprout inhibiting compound to tubers, the system utilizing drip orifices mounted on a reciprocating trolley for supplying the sprout inhibiting compound to the upper layer of brushes;

FIG. 3 is an elevational view of a double layer rotating brush system in which both the upper set of brushes and drip orifices are mounted on a reciprocating trolley;

FIG. 4 is an elevational view of a double-layer rotating brush system for applying a sprout inhibiting compound to tubers, the system utilizing spray nozzles mounted on a reciprocating trolley for supplying the sprout inhibiting compound to the upper layer of brushes;

FIG. 5 is a top plan view of a cylindrical upper brush having a right-hand helical groove;

FIG. 6 is a top plan view of a cylindrical upper brush having a left-hand helical groove;

FIG. 7 is an elevational view of a system for applying a sprout inhibiting compound to tubers, the system utilizing lower cylindrical brushes and a single, track-mounted reciprocating flat brush and drip applicators within the brush for supplying the sprout inhibiting compound to the upper layer of brushes;

FIG. 8 is a plan view of a lower set of cylindrical brushes;

FIG. 9 is a plan view of an upper set of right-conical section brushes;

FIG. 10 is a plan view of the upper set of right-conical section brushes of FIG. 9 superimposed on the lower set of cylindrical brushes of FIG. 8;

FIG. 11 is an elevational end view of the brush arrangement of FIG. 10, showing tubers between transported between the upper and lower sets of brushes; and

FIG. 12 is a double-layer rotating brush system having a first set of cylindrical lower brushes having parallel axes in a common plane and an upper set of three cylindrical brushes having splayed axes in a common plane.

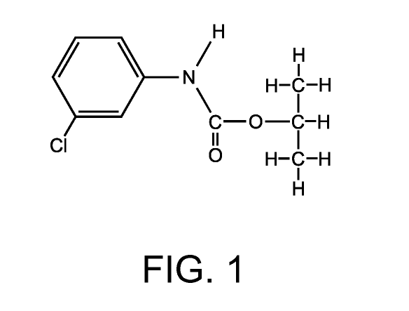

### PREFERRED EMBODIMENT OF THE INVENTION

The invention will now be described with reference to the attached drawing figures. It should be understood that the drawings are not necessarily drawn to scale and that they are intended to be merely illustrative of the apparatus and tuber treatment method.

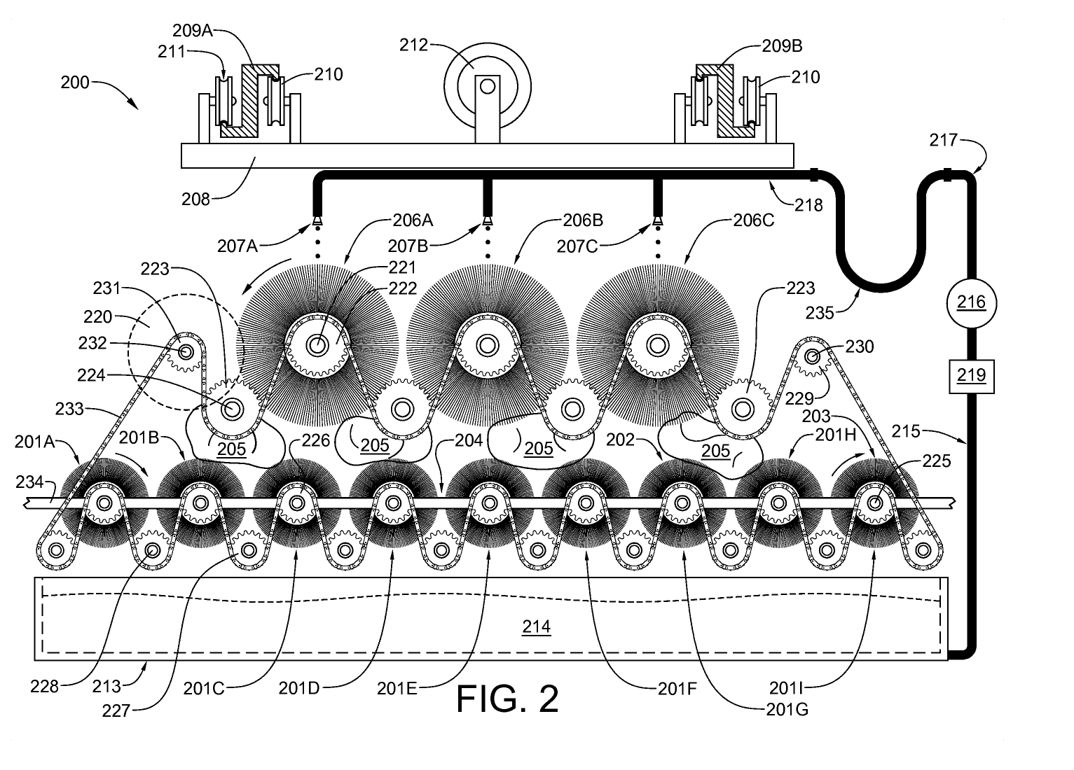

Referring now to FIG. 2, a first embodiment double-layer rotating brush system 200 for applying a sprout inhibiting compound in a emulsion form on tubers utilizes a set of lower cylindrical brushes 201A-201I, which are positioned sufficiently close to one another so as to provide a rolling platform 202 of a width determined by the axial length of the brushes 201A-201I, the platform 202 having a series of alternating peaks 203 and troughs 204 for the transport of tubers 205 through the system. The system 200 also utilizes an upper set of cylindrical brushes 206A, 206B and 206C to which the emulsion is applied by means of drippers 207A, 207B and 207C, each of which is positioned above one of the brushes of the upper set. For this particular embodiment, the drippers 207A, 207B and 207C are attached to a trolley 208, which is mounted on a horizontal track consisting of two horizontal rails 209A and 209B. Each of the rails 209A and 209B is positioned transverse to a path down the center of the rolling platform 202. It will be noted that guide wheels 210, each of which has an annular groove 211, are secured to the trolley 208 and slidably lock the trolley 208 to the rails 209A and 209B. A double-acting pneumatic cylinder 212 moves the trolley back and forth at a generally constant rate of speed. A drip receptacle 213 serves and an emulsion supply tank and catches emulsion 214 that drips from the upper and lower sets of brushes and does not remain on the tubers 205. A first emulsion conduit 215 interconnects the drip receptacle 213 to a pump 216, while a second emulsion conduit 217 interconnects the pump 216 to the dripper assembly 218, which includes the three drippers 207A, 207B and 207C. In order to protect the pump from grit and other foreign matter, a filter 219 is placed between the drip receptacle 213 and the pump 216. For this particular embodiment, both the upper and lower sets of brushes are driven by a single electric drive motor 220 that is shown in outline form. Each of the upper set of brushes 206A, 206B and 206C is mounted on an upper axle shaft 221 having an upper drive sprocket 222 attached to an end thereof. Each of the upper axle shafts 221 is mounted in sealed bearings which are held in place by bearing blocks (neither of which are shown). Four upper idler sprockets 223 are also mounted below the upper drive sprockets 222 on upper idler shafts 224 which extend outwardly to sealed bearing mounted in bearing supports (neither of which are shown) that are spaced away from the brushes to provide clearance for the tubers 205. Each of the lower set of brushes 201A-201I is mounted on a lower axle shaft 225 having a lower drive sprocket 226 attached to an end thereof. Each of the lower axle shafts 225 is mounted in sealed bearings which are held in place by bearing blocks (neither of which are shown). Eleven lower idler sprockets 227 are also mounted on lower idler shafts 228 which are mounted in sealed bearing races held in place by bearing supports (neither of which are shown). A single tension adjustment idler sprocket 229 is mounted on an adjustable idler shaft 230 above the upper idler sprockets 223. A motor sprocket 231 is mounted on one end of the drive motor shaft 232. It should be obvious that the motor sprocket 231, the upper drive sprockets 222, the upper idler sprockets 223, the lower drive sprockets 226, the lower idler sprockets 227 and the tension adjustment idler sprocket 229 are positioned in a common plane and interconnected by a single drive chain 233. Given the sprocket and chain arrangement, it should be clear that, from this vantage point, as the motor turns counterclockwise, each of the brushes 206A, 206B and 206C of the upper brush set also revolves in a counterclockwise direction, while each of the brushes 201A-201I of the lower brush set revolve in a clockwise direction. Each of the lower axle shafts 225 is rotatably affixed to a frame member 234. It should also be evident that lower idler shafts 228, the adjustable idler shaft 230, each of the upper axle shafts 221, and each of the upper idler shafts 224 are also rotatably affixed to a frame portion that is rigidly tied to frame member 234. The electric drive motor 220, the trolley rails 209A and 209B and one end of the double-acting pneumatic cylinder 212 are, of course, all rigidly tied to frame member 234. It will also be noted that the second emulsion conduit 217 includes a flexible U-shaped portion 235 that permits the trolley 208 to move without breaking the second emulsion conduit 217.

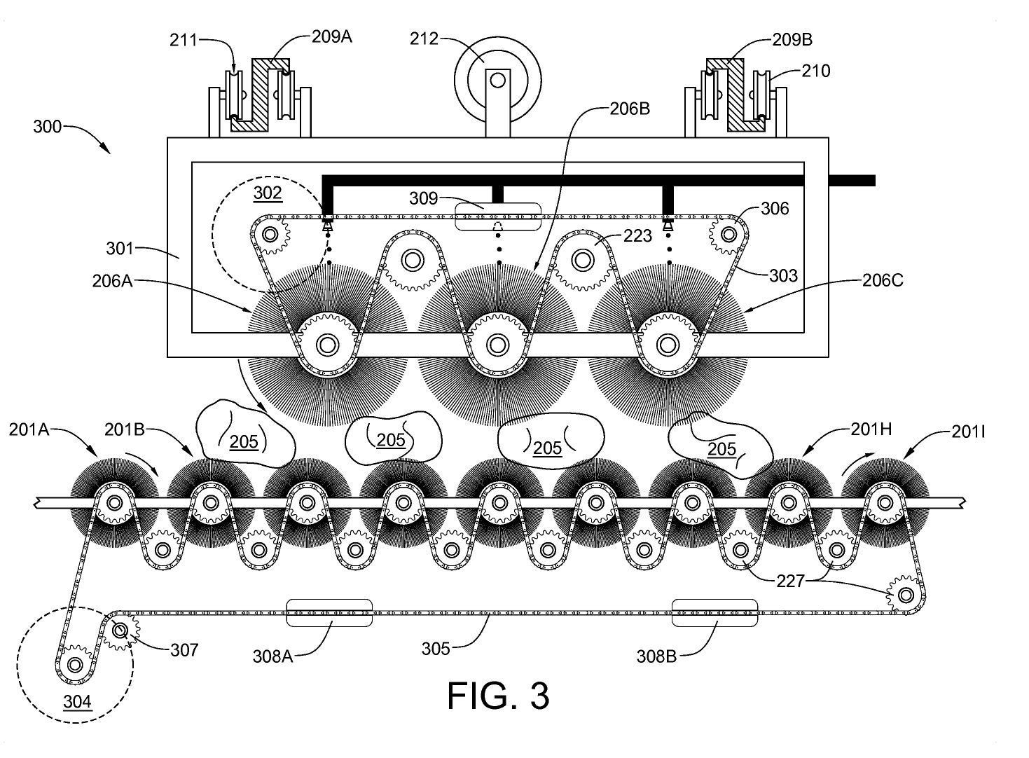

Referring now to FIG. 3, an enhanced version 300 of the first embodiment double-layer rotating brush system 200 is shown. The primary change is the mounting of the upper set of brushes 206A, 206B and 206B on a trolley 301, along with the dripper assembly 218. This, of course, necessitates the use of two separate drive motors and two separate drive chains: an upper drive motor 302 and an upper drive chain 303 to drive the upper set of brushes 206A, 206B and 206C, and a lower drive motor 304 and a lower drive chain 305 to drive the lower set of brushes 201A-201I. Other changes were the rearrangement of the upper idler sprockets 223, the lower idler sprockets 227, and replacement of the tension adjustment idler sprocket 229 with an upper tension adjustment idler sprocket 306 and a lower tension adjustment idler sprocket 307. In addition, lower chain guide blocks 308A and 308B minimize chain slap by the lower drive chain 305 and upper chain guide block 309 minimizes chain slap by the upper drive chain 303.

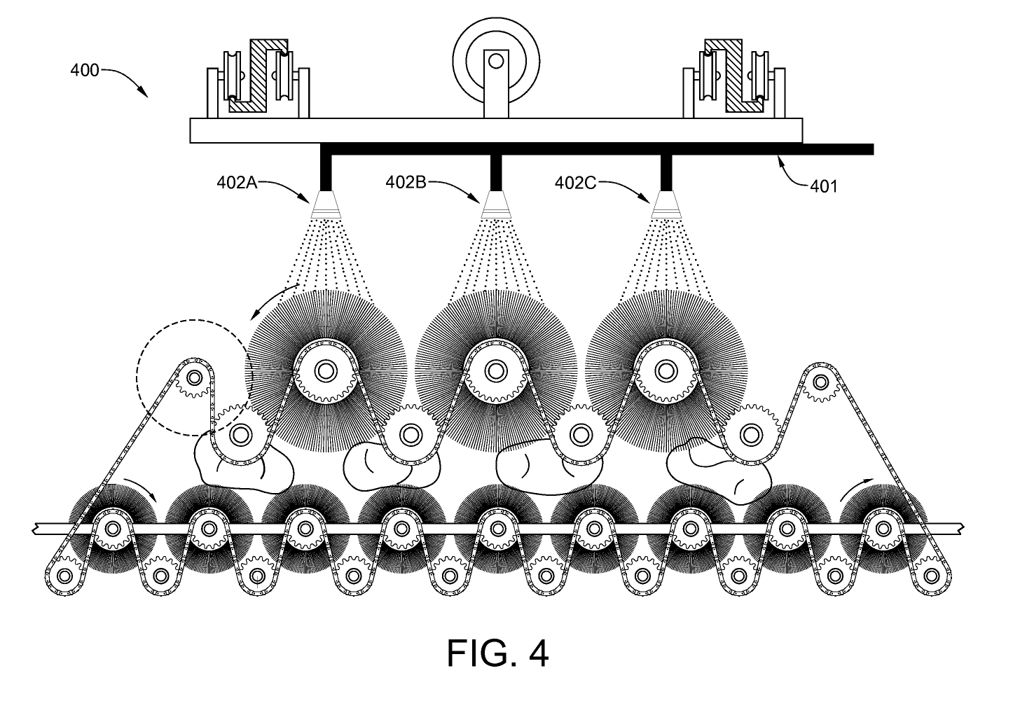

Referring now to FIG. 4, a second embodiment double-layer rotating brush system 400 is identical to the first embodiment double-layer rotating brush system 200 of FIG. 2, with the exception that the dripper assembly 218 and drippers 207A, 207B and 207C are replaced with a spray assembly 401 with multiple sprayers 402A, 402B and 402C.

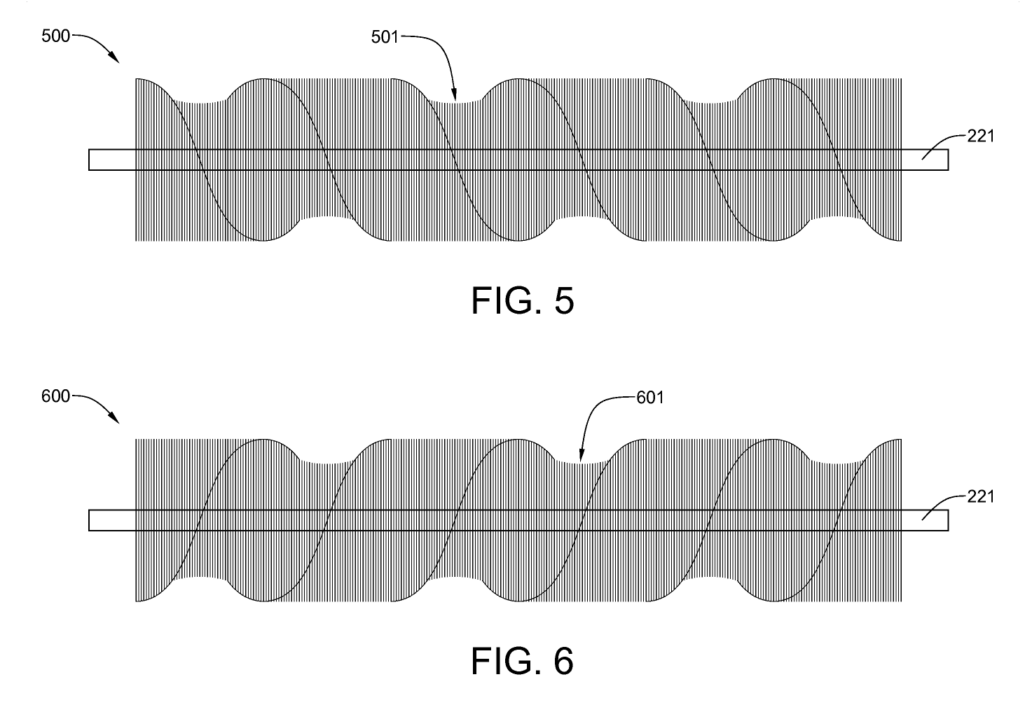

Referring now to FIG. 5, a cylindrical brush 500 for the upper brush set of the double-layer rotating brush system 200 or 400 of FIGS. 2 and 4, respectively, has a right-hand helical groove 501. The groove 501 will promote rolling and tumbling of the treated tubers 205.

Referring now to FIG. 6, a cylindrical brush 600 for the upper brush set of the double-layer rotating brush system 200 or 400 of FIGS. 2 and 4, respectively, has a left-hand helical groove 601. The groove 601 will promote rolling and tumbling of the treated tubers 205. So that the tubers are not directed to a single side of the track, brushes having right-hand grooves 501 and left-hand grooves 601 are installed in pairs. The use of grooved cylindrical brushes 500 and 600 is intended for use on a third embodiment double-layer rotating brush system which eliminates the incentive to mount the upper set of brushes 206A, 206B and 206C on a reciprocally and laterally-movable trolley 301.

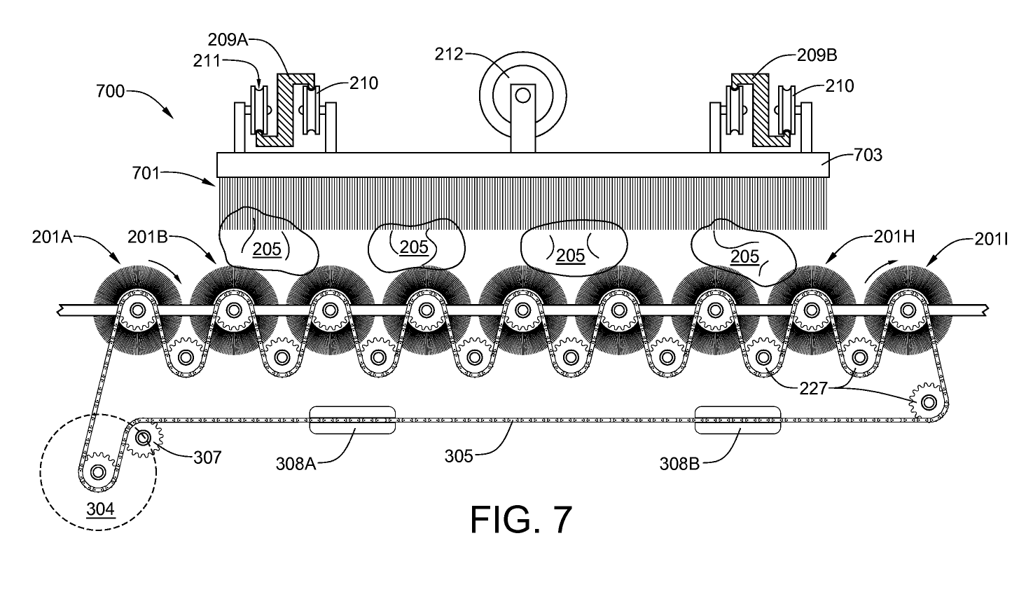

Referring now to FIG. 7, a fourth embodiment double-layer brush system 700 includes a lower set of rotating cylindrical brushes 201A-201I and at least one single flat brush 701 and drippers 702A, 702B and 702C within the flat brush. As the flat brush 701 is unable to rotate, the entire transport task is handled by the lower set of cylindrical brushes 201A-201I. Although the flat brush or brushes 701 may be stationary, rolling and tumbling of the tubers 205 will be enhanced by mounting the flat brush or brushes 701 on reciprocally and laterally-movable trolley 703.

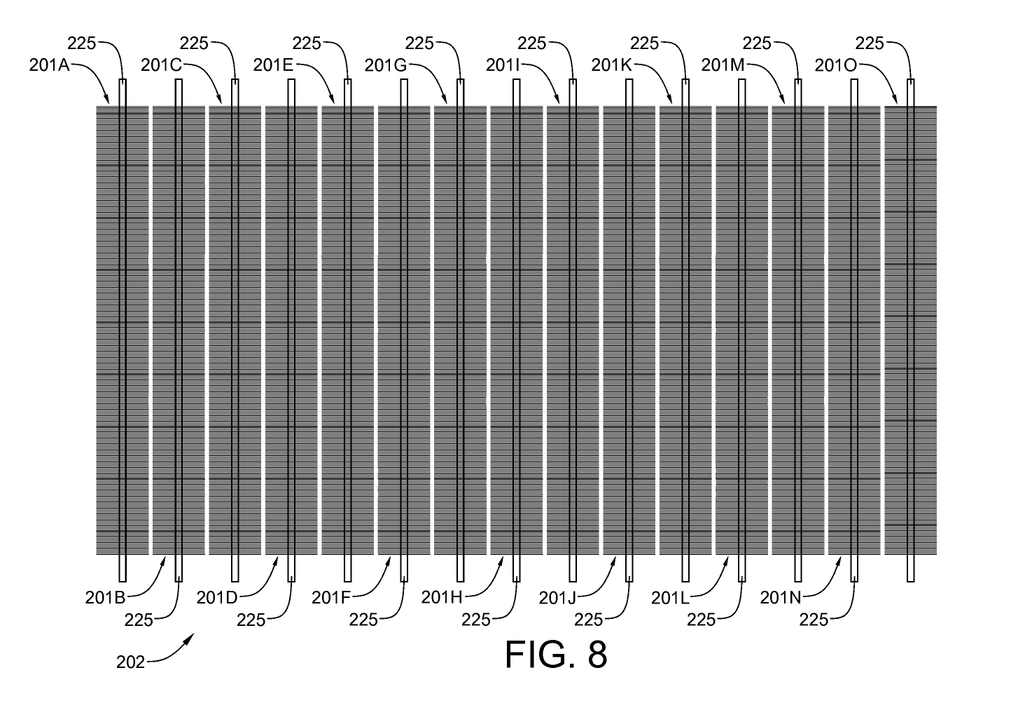

Referring now to FIG. 8, the lower set of brushes 201A-201I of FIGS. 2, 3, 4 and 7 are shown from above. This will also be the starting point for a fifth embodiment double-layer brush system.

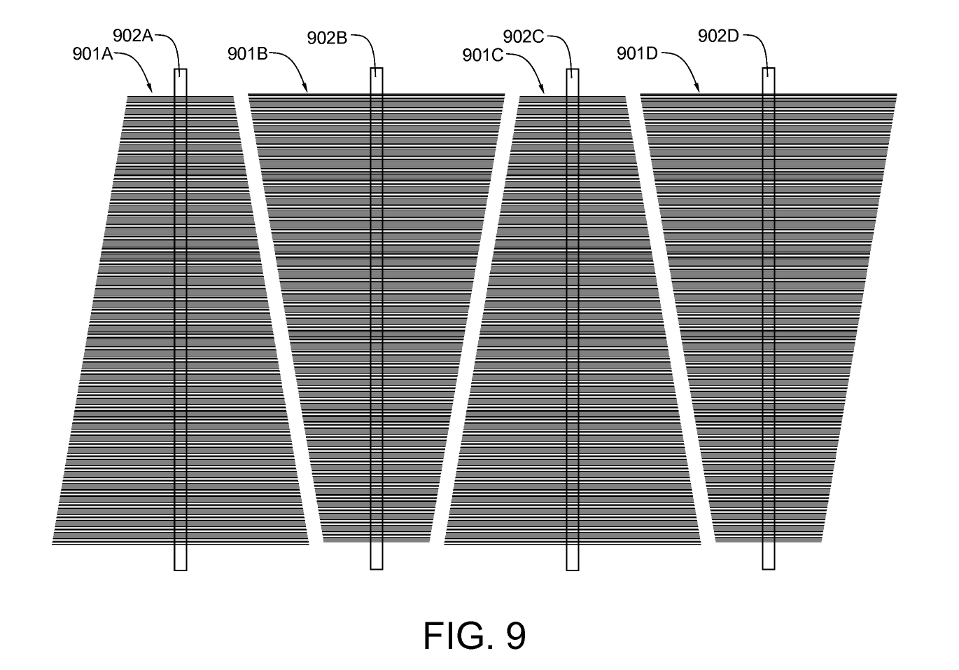

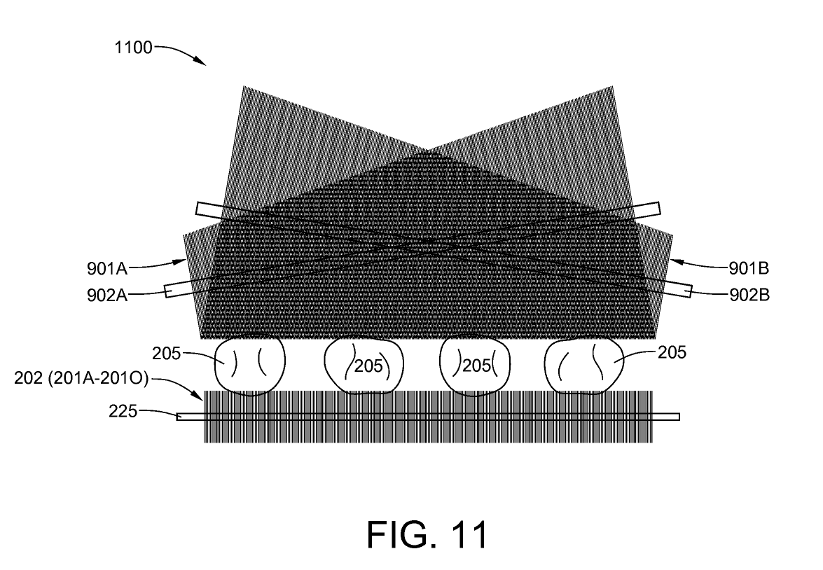

Referring now to FIG. 9, an upper set of right-conical section brushes 901A, 901B, 901C and 901D is shown. Each of the right-conical section brushes 801A, 901B, 901C and 901D has a central axle shaft 902A, 902B, 902C and 902D, respectively. It will be noted that the orientation of each brush is reversed from those immediately adjacent thereto. Though the axle shafts 902A, 902B, 902C and 902D appear to be parallel, they are actually inclined within parallel planes, such that the lower ends of axle shafts 902A and 902C and the upper ends of axle shafts 902B and 902D are at greater common elevational height than the upper ends of axle shafts 902A and 902C and the lower ends of axle shafts 902B and 902D, which are at a lower common elevational height. For the sake of ease of drawability, the drawing is not completely accurate, as the large-diameter and small-diameter ends of each right-conical section brush would actually be shown as ellipsoid in this view. However, the difficultly of accurately drawing the bristles of each brush in the tilted configuration would be a gargantuan task. FIG. 11 is included to provide a tilted perspective.

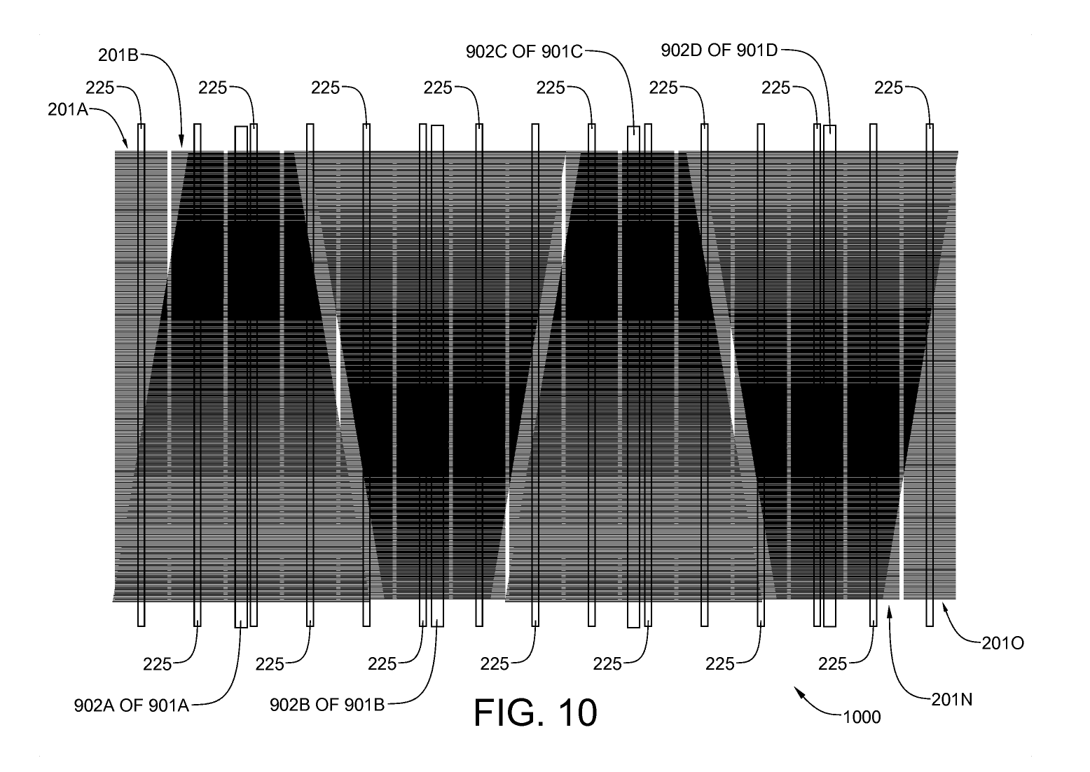

Referring now to FIG. 10, the upper set of right-conical section brushes 901A, 901B, 901C and 901D has been superimposed on the lower set of brushes 201A-201I, resulting in a fifth embodiment 1000 of the double-layer rotating brush system.

Referring now to FIG. 11, the upper set of right-conical section brushes 901A, 901B, 901C and 901D and the lower set of brushes 201A-201I of the fifth embodiment system 1000 are seen in an end view with tubers 205 passing between both sets. It will be noted that each of the right-conical section brushes 901A, 901B, 901C and 901D has been tilted so that the lowermost edge of the bristle face 1101 is parallel to the axes of the lower set of brushes 201A-201I. In reality, only brushes 201A, 901A and 901B are visible in this end view. The use of the right-conical section brushes 901A, 901B, 901C and 901D creates a speed differential of the bristles of each brush over the length of the brush that is proportional to the distance from the apex of the cone. Although each cone has been truncated, so that the apex has been removed, the bristle face 1101 of each brush still tapers to a theoretical apex. The speed differential between the various bristles as a function of distance from the theoretical apex generates a spinning moment in a horizontal plane on each of the tubers as they travel on the lower set of brushes.

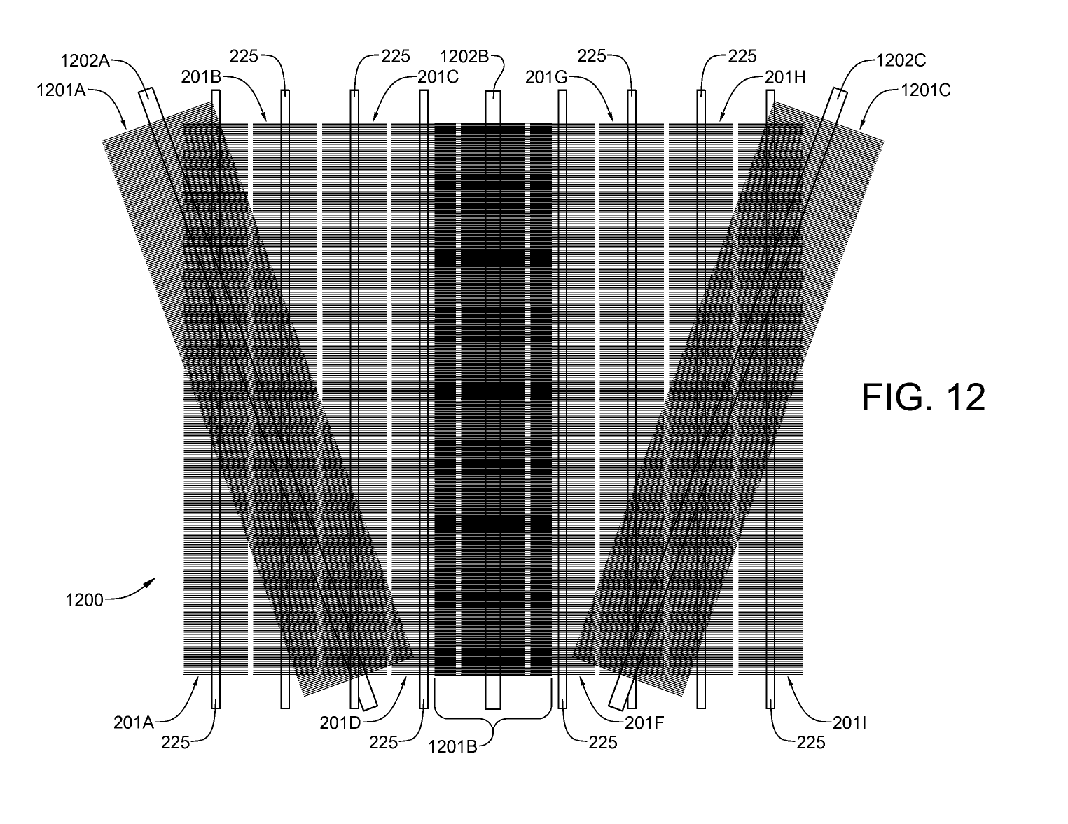

Referring now to FIG. 12, a sixth embodiment double layer rotating brush system 1200 has a lower set of cylindrical lower brushes 201A-201I having parallel axes in a common plane and a second set of three cylindrical upper brushes 1201A, 1201B and 1201C having splayed axes 1202A, 1202B and 1202C, respectively, in a common plane. So that the tubers are not directed to a single side of the track, brushes having rotational axes which are non-parallel to the rotational axes of the cylindrical brushes of the lower set are installed in oppositely-angled pairs. In this case, brushes 1201A and 1201C are an oppositely-angled pair.

It should be evident that any arrangement of brushes with non-parallel axes, such as those of FIGS. 11 and 12 complicates the drive system for those brushes. However, the brushes with non-parallel axes can be powered individually with a separate motor for each brush, or powered with a single motor using a single belt or chain through a system of flexible couplers, U-joints or constant-velocity joints, or even bevel gear drives.

Though not shown in the drawings, it should be understood that walls or railings are to be used on both sides of the rolling platform 202 in order to keep the tubers from rolling off the platform and into the drive mechanism, for example, during the treatment process.

Although the double layer brush system disclosed herein was developed for applying emulsions containing isopropyl-3-chlorocarbonilate to tubers, it is also contemplated that the method and apparatus may be used to apply other sprout inhibiting compounds, such as maleic hydrazide or essential oils, to tubers or, more generally, to apply liquids containing a post-harvest-treatment organic compound to any generally spherical or ovoid agricultural produce items. It is further contemplated that the organic compounds—whether they be sprout inhibitors or other post-harvest-treatment compounds—may be applied as a solution, a diluted or concentrated organic liquid, or as a water-based emulsion, depending on the physical properties of the organic compound.

Although only several embodiments of the invention are shown and described herein, it will be obvious to those having ordinary skill in the art that changes and modifications may be made thereto without departing from the scope and the spirit of the invention as hereinafter claimed.

What is claimed is:

1. An apparatus for applying a liquid containing a post-harvest-treatment organic compound to agricultural produce items having a generally spherical and ovoid shapes, said apparatus comprising:
a first set of generally cylindrical brushes, each of which is rotatable about its axis in a common first direction of rotation, the axes of said first set of brushes being generally parallel and lying in generally in a common plane, said first set of cylindrical brushes being positioned sufficiently close to one another so as to provide a rolling platform of a width determined by a length of the brushes of said first set, said platform having a series of alternating peaks and troughs for the transport of said produce items through said apparatus;
a second brush set positioned above said first set so that a distance between said first and second sets is generally less than an average minimum diameter of said produce items over said platform width;
a supply tank fillable with said liquid; and
means for controllably delivering the liquid within said supply tank to at least one brush of said second set.

2. The apparatus of claim 1, wherein said liquid is an emulsion containing the sprout-inhibiting organic compound isopropyl-3-chlorocarbonilate, and the produce items are tubers that have been removed from storage prior to distribution.

3. The apparatus of claim 1, which further comprises:
a drip receptacle for recovering the liquid that drips from said first and second sets of brushes and does not remain on the produce items, said drip receptacle also serving as a liquid supply tank;
a filter for filtering the liquid before it is applied to said at least one brush of said second set; and
a pump for delivering the liquid from said drip receptacle to said filter and to said means for controllably delivering.

4. The apparatus of claim 1, wherein said means for controllably applying comprises at least one applicator selected from the group consisting of drippers and sprayers.

5. The apparatus of claim 4, wherein said at least one applicator is mounted on a trolley mounted on a track positioned above said second brush set, said trolley being movable on said track so that said liquid can be applied to at least one brush of said second set over generally the entire width of the rolling platform.

6. The apparatus of claim 5, wherein said trolley is motivated by a double-action pneumatic cylinder.

7. The apparatus of claim 1, wherein said second brush set comprises multiple cylindrical brushes rotatable in a direction opposite to that of the brushes of said first set, said cylindrical brushes of said second set having horizontally disposed parallel axes.

8. The apparatus of claim 7, wherein the cylindrical brushes of said second set are mounted on a trolley that is reciprocally and bidirectionally movable in a horizontal plane and in directions that are generally perpendicular to a path down a center of the rolling platform created by the first set of brushes.

9. The apparatus of claim 1, wherein said second brush set comprises at least one flat brush.

10. The apparatus of claim 9, wherein said second brush set is mounted on a trolley that is reciprocally and bidirectionally movable in a horizontal plane and in directions that are generally perpendicular to a path of down a center of the rolling platform created by said first set of brushes.

11. The apparatus of claim 7, wherein at least one brush of said second set of generally cylindrical brushes is equipped with a right-hand groove and at least one other of the same set is equipped with a left-hand helical groove, so that as the brushes rotate, the helical grooves promote rolling and tumbling of the produce items.

12. The apparatus of claim 1, wherein said second brush set comprises multiple right-conical section brushes rotatable in a direction opposite to that of the brushes of said first set, each of said right-conical section brushes having an axis non-horizontally positioned in a plane that is perpendicular to a path down a center of the rolling platform created by said first set of brushes.

13. The apparatus of claim 1, wherein said second brush set comprises multiple cylindrical brushes rotatable in a direction opposite to that of the brushes of said first set, said brushes of said second set having non-parallel horizontal axes.

14. An apparatus for applying a liquid containing a post-harvest-treatment organic compound to agricultural produce items having a generally spherical and ovoid shapes, said apparatus comprising:
a first set of generally cylindrical brushes, each of which is rotatable about its axis in a common first direction of rotation, the axes of said first set of brushes being generally parallel, said first set of cylindrical brushes being positioned sufficiently close to one another so as to provide a rolling platform of a width determined by a length of the brushes of said first set, said platform having a series of alternating peaks and troughs for the transport of said produce items through said apparatus;
a second brush set positioned above said first set so that as a produce item is transported along said rolling platform, it makes simultaneous contact with a brush of each set; and
means for controllably delivering the liquid to at least one brush of said second set.

15. The apparatus of claim 14, wherein said means for controllably delivering comprises:
a plurality of liquid discharge devices selected from the group consisting of drippers and sprayers;
a drip receptacle for recovering liquid that drips from said first and second sets of brushes and does not remain on the produce items, said drip receptacle also serving as a liquid supply tank;
a pump;
conduit interconnecting said drip receptacle to said pump and said pump to said discharge devices; and
a filter for filtering the liquid before it enters said pump.

16. The apparatus of claim 15, wherein said emulsion discharge devices are affixed to a trolley movably mounted on a track positioned above said second set of brushes, said trolley providing lateral reciprocal movement so that the liquid is generally evenly discharged from one end of at least one brush of said second set to an opposite end thereof.

17. The apparatus of claim 14, wherein said second brush set comprises multiple cylindrical brushes rotatable in a direction opposite to that of the brushes of said first set, said cylindrical brushes of said second set having horizontally disposed parallel axes.

18. The apparatus of claim 17, wherein the cylindrical brushes of said second set are mounted on a trolley that is reciprocally and bidirectionally movable in a horizontal plane and in directions that are generally perpendicular to a path down a center of the rolling platform created by the first set of brushes.

19. The apparatus of claim 17, wherein at least one brush of said second set of generally cylindrical brushes is equipped with a right-hand groove and at least one other of the same set is equipped with a left-hand helical groove, so that as the brushes rotate, the helical grooves promote rolling and tumbling of the produce items.

20. The apparatus of claim 17, wherein said second brush set comprises multiple right-conical section brushes rotatable in a direction opposite to that of the brushes of said first set, each of said right-conical section brushes having an axis non-horizontally positioned in a plane that is perpendicular to a path down a center of the rolling platform created by said first set of brushes.
